(19) United States
(12) Patent Application Publication
(10) Pub. No.: US 2026/0157363 A1
(43) Pub. Date: Jun. 11, 2026

(54) BIRD STRIKE AVOIDANCE ASSEMBLY FOR AIRCRAFT

(71) Applicant: CHRISTOPHER J. GILL, GREENVILLE, SC (US)

(72) Inventor: CHRISTOPHER J. GILL, GREENVILLE, SC (US)

(21) Appl. No.: 18/983,880

(22) Filed: Dec. 17, 2024

Related U.S. Application Data
(60) Provisional application No. 63/611,184, filed on Dec. 17, 2023.

(51) Int. Cl. A01M 29/16; B64D 15/00; B64D 45/00; H04R 1/02; H04R 1/40

(52) U.S. Cl. CPC A01M 29/16; B64D 15/00; B64D 45/00; H04R 1/025; H04R 1/403; B64D 2045/0095; H04R 2499/13

(57) ABSTRACT

An assembly for aircraft to prevent bird strikes by deterring the birds using an 18 kHz signal. The assembly can be installed on the front of the aircraft. Each assembly includes a radio transmitter configured to generate an 18 kHz signal with a 5-10-mile range.

### CROSS-REFERENCE TO RELATED APPLICATIONS

This application claims priority from a U.S. Provisional Patent Appl. No. 63/611,184, filed on Dec. 17, 2023, which is incorporated herein by reference in its entirety.

### FIELD OF INVENTION

The present invention relates to an assembly for avoiding bird strikes, and more specifically, the present invention relates to an assembly for aircraft to deter birds for preventing bird strikes.

### BACKGROUND

Bird strikes pose a significant threat to flight safety. Bird strike typically refers to the collision of an airborne bird with an aircraft during landing and takeoff. Bird collisions with airplanes have been responsible for several accidents. Detering birds from aircraft during takeoff and landing has been a major challenge and a big worry for concerned authorities. These collisions can seriously damage important parts of an airplane such as engines and wings. Severe collision may lead to aircraft failure resulting in loss of life and property. Also, any harm to birds is undesirable.

Thus, a long-term solution is needed to deter birds from airplanes during take-off, landing, and flight. A need is there for an assembly to avoid bird strikes.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an assembly for aircraft for avoiding bird strikes.

Another object of the present invention is that the assembly can deter birds.

Still another object of the present invention is that the assembly is easy to install.

A further object of the present invention is to make a safer environment for both aircraft and passengers.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a sectional view of the assembly, according to an exemplary embodiment of the present invention.

FIG. 2 shows an aircraft with the disclosed assembly installed, according to an exemplary embodiment of the present invention.

FIG. 3 shows a close-up view of an aircraft section containing the assembly, according to an exemplary embodiment of the present invention.

FIG. 4 shows a speaker of the assembly, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is an assembly that can deter birds to prevent bird strikes. The disclosed assembly can be used in aircraft to prevent bird strikes. Also, the aircraft containing the assembly disclosed are disclosed. The disclosed assembly can easily be installed in an aircraft and can deter birds from reaching the engine and other sensitive components of the aircraft. The assembly can deter the birds without causing any harm to the birds.

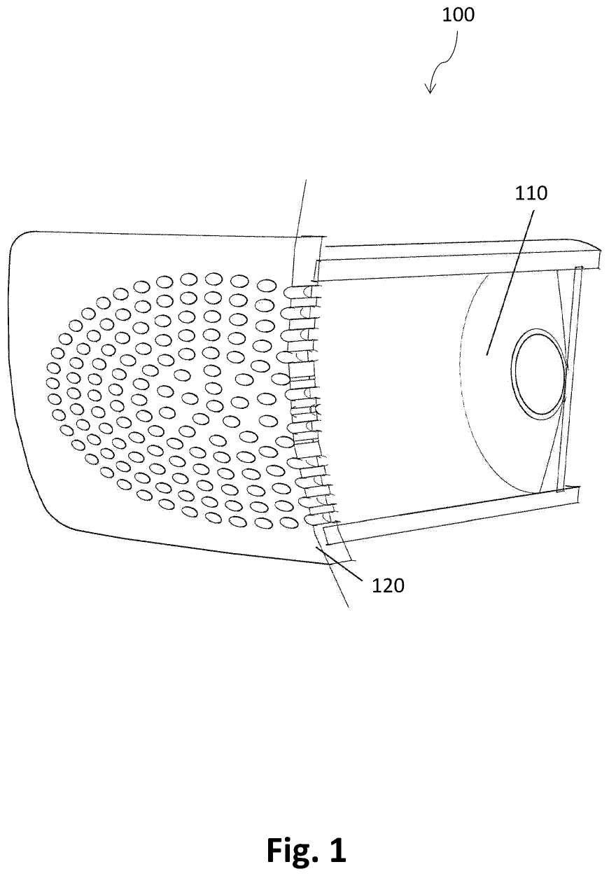

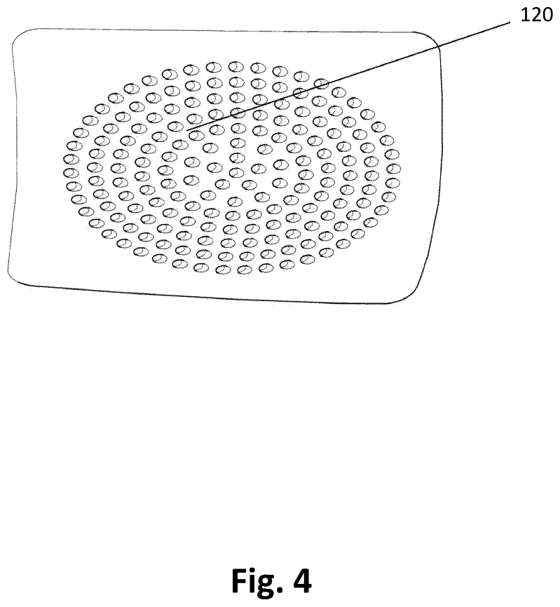

Referring to FIGS. 1-4 which shows different features of the assembly. The disclosed assembly includes a radio transmitter that can generate an 18 kHz signal with a 5-10-mile range. The assembly can project the signal at a 45-degree angle from the aircraft at different locations. This signal can deter birds near the aircraft from getting away from the aircraft, thus preventing the birds from striking sensitive components of the aircraft. The position and arrangement of the radio transmitters on the aircraft is a critical feature of the invention that generates a virtual shield area against the birds.

The disclosed assembly significantly reduces the risk of damage to aircraft caused by bird strikes during takeoff and landing. By preventing or minimizing damage due to bird strikes, the disclosed assembly can result in cost savings associated with aircraft repairs and maintenance. The flights can become safer, and airline operators can expect increased reliability in their operations as the assembly contributes to a reduction in the frequency and impact of bird strikes. Also, the disclosed assembly can boost the passengers'confidence in air travel. Also, by mitigating the chances of damage caused by bird strikes, the disclosed assembly may help reduce the likelihood of flight delays or cancellations due to unscheduled maintenance, providing a more reliable and convenient travel experience for passengers.

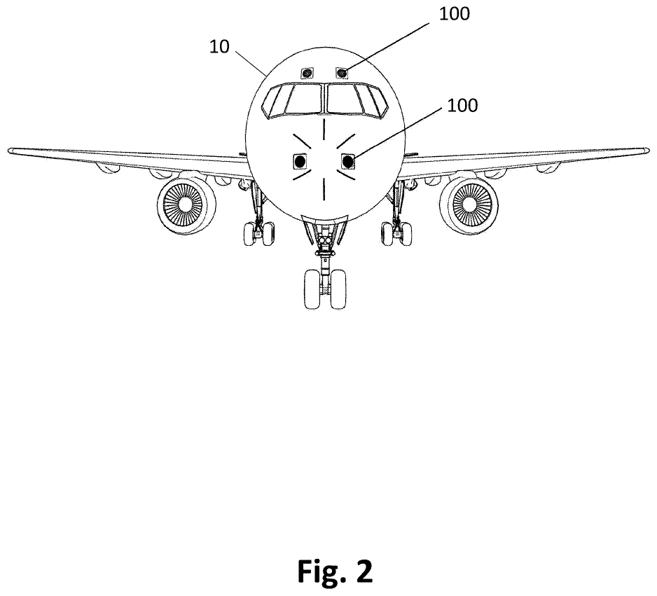

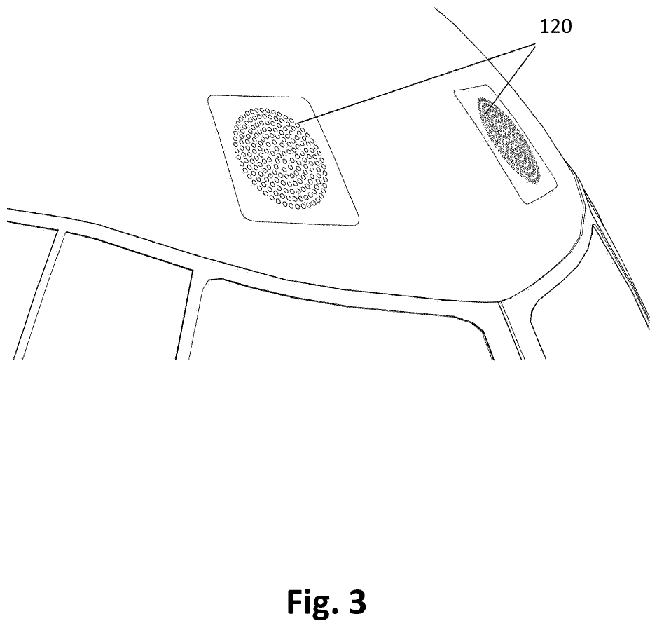

FIG. 1 shows a sectional view of assembly 100 that includes a transmitter/speaker 110 and a deicer 120. The deicer 120 includes holes for the signal to propagate through. FIG. 2 shows the arrangement and positioning of the assembly 100 on an aircraft 10. As shown in FIG. 2, the aircraft has two primary speaker assemblies positioned around the nose of the aircraft. The two primary speaker assemblies are on the left and right sides of the nose of the aircraft. Two secondary speaker assemblies are positioned above the windshield. FIG. 3 shows the close-up view of the assembly showing the deicer. The assemblies are positioned at 45 degrees relative to a traversal plane. The four assemblies positioned at relativity four corners of an imaginary rectangle in front of the aircraft can create a shield area of the 18 kHz signal that deters the birds and prevents them from reaching the engine and other sensitive areas of the aircraft. The traversal plane horizontally cuts the aircraft and lies perpendicular to the length of the aircraft.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An assembly for an aircraft to prevent bird strikes, the assembly comprising:
a radio transmitter configured to generate an 18 kHz signal with a 5-10-mile range.

2. The assembly according to claim 1, wherein the assembly further comprises a deicer configured to protect the radio transmitter.

3. A method for avoiding bird strikes, the method comprising:
installing two primary speaker assemblies near a nose of an aircraft; and
installing two secondary speaker assemblies above a windshield of the aircraft, wherein each of the two primary speaker assemblies and the two secondary speaker assemblies comprises a radio transmitter configured to generate an 18 kHz signal with a 5-10-mile range.

4. The method of claim 3, wherein each of the two primary speaker assemblies and the two secondary speaker assemblies are positioned at 45 45-degree angles relative to a traversal plane.

5. An aircraft comprises:
two primary speaker assemblies positioned near a nose of an aircraft; and
two secondary speaker assemblies positioned above a windshield of the aircraft, wherein each of the two primary speaker assemblies and the two secondary speaker assemblies comprises a radio transmitter configured to generate an 18 kHz signal with a 5-10-mile range.

6. The aircraft of claim 5, wherein each of the two primary speaker assemblies and the two secondary speaker assemblies are positioned at 45 45-degree angles relative to a traversal plane.
